(19) United States
(12) Patent Application Publication
(10) Pub. No.: US 2016/0259214 A1
(43) Pub. Date: Sep. 8, 2016

(54) DISPLAY MOTHERBOARD, DISPLAY PANEL MADE FROM DISPLAY MOTHERBOARD, AND MANUFACTURING METHOD THEREOF

(71) Applicant: SHENZHEN CHINA STAR OPTOELECTRONICS TECHNOLOGY CO., LTD, Shenzhen, Guangdong (CN)

(72) Inventor: Tao LIU, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/647,112

(22) PCT Filed: Sep. 23, 2013
(86) PCT No.: PCT/CN2013/084033

§ 371 Date: May 25, 2015

(30) Foreign Application Priority Data
Sep. 5, 2013 (CN) 201310400495.2

(51) Int. Cl. G02F 1/1337; G02F 1/1345; G02F 1/1343; G02F 1/1368; G02F 1/1335; G02F 1/1339

(52) U.S. Cl. CPC G02F 1/133788; G02F 1/133514; G02F 1/133723; G02F 1/1339; G02F 1/134309; G02F 1/1368; G02F 1/13452

(57) ABSTRACT

The present invention discloses a display motherboard including a first substrate, a second substrate, and a number of liquid crystal molecules set between the first and second substrates. Each of the first and second substrates includes a display area and a non-displaying area. The liquid crystal molecules are sealed between the first and second substrates by a number of sealants. An electrode is set on the displaying area of the first and second substrates. The non-displaying area of at least one of the first and second substrates includes an effective part adjacent to the displaying area, a cutting part located at a peripheral of the effective part, a controlling circuit for controlling a voltage applied to the electrode, a number of connecting terminals of the controlling circuit set on the cutting part, and an insulating pattern corresponding to the controlling circuit. The insulating pattern is not set on the connecting terminals.

### FIELD OF THE INVENTION

The invention relates to display technologies, and particularly, to a display motherboard, a display panel made from the display motherboard, and manufacturing method thereof.

### BACKGROUND OF THE INVENTION

A pretitle angle of liquid crystal molecules is processed a curing treatment by applying an ultraviolet light in cooperation with an appropriate curing voltage during a liquid crystal alignment. The circuit used to apply the curing voltage is called a curing circuit. However, during the manufacture of the liquid crystal panel, a lot of metal particles or conductive impurities may fall on the curing circuit and cause a short between the curing circuit and the other circuit on the liquid crystal panel. Thus, the liquid crystal alignment is adversely affected due to the curing voltage fail to apply.

Therefore, a display motherboard, a display panel made from the display motherboard, and manufacturing method thereof which can solve the above-mentioned problem needs to be provided.

### SUMMARY OF THE INVENTION

To solve the above-mentioned problem, the present invention provides a display motherboard including a first substrate, a second substrate, and a number of liquid crystal molecules set between the first and second substrates. Each of the first and second substrates includes a display area and a non-displaying area. The liquid crystal molecules are sealed between the first and second substrates by a number of sealants. An electrode is set on the displaying area of the first and second substrates. The non-displaying area of at least one of the first and second substrates includes an effective part adjacent to the displaying area, a cutting part located at a peripheral of the effective part, a controlling circuit for controlling a voltage applied to the electrode, a number of connecting terminals of the controlling circuit set on the cutting part, and an insulating pattern corresponding to the controlling circuit. The insulating pattern is not set on the connecting terminals.

Wherein, the first substrate is a thin film transistor substrate.

Wherein, the second substrate is a color filter substrate.

Wherein, the controlling circuit on the non-displaying area of the first substrate is a curing circuit for the photo-alignment treatment.

Wherein, the electrode set on the displaying area of the first substrate is a pixel electrode. The pixel electrode is connected to the curing circuit.

Wherein, the location of the insulating pattern is selected from the group consisting of a position in the non-displaying corresponding to the curing circuit and a position on the curing circuit.

Wherein, the electrode on the second substrate is a common electrode and the common electrode covers the non-displaying area and the displaying area of the second substrate.

Wherein, a material of the insulating pattern is polymer alignment film.

A display panel includes a first substrate, a second substrate opposite to the first substrate, and a number of liquid crystal molecules sealed between the first substrate and the second substrate by a number of sealants. Each of the first substrate and the second substrate includes a display area, a non-displaying area, an electrode set on the displaying area, a controlling circuit remains on the non-displaying area of at least one of the first substrate and the second substrate after being cut, and an insulating pattern corresponding to the remaining controlling circuit.

Wherein, the first substrate is a thin film transistor substrate.

Wherein, the second substrate is a color filter substrate.

Wherein, the controlling circuit on the non-displaying area of the first substrate is a curing circuit for the photo-alignment treatment.

Wherein, the electrode set on the displaying area of the first substrate is a pixel electrode, and the pixel electrode is connected to the curing circuit.

Wherein, the location of the insulating pattern is selected from the group consisting of a position in the non-displaying corresponding to the curing circuit and a position on the curing circuit.

Wherein, the electrode on the second substrate is a common electrode and the common electrode covers the non-displaying area and the displaying area of the second substrate.

Wherein, a material of the insulating pattern is polymer alignment film.

A manufacturing method of a display panel includes providing a first substrate and a second substrate parallel to the first substrate, wherein each of the first substrate and the second substrate comprises a display area and a non-displaying area, and the non-displaying area of at least one of the first substrate and the second substrate comprises an effective part adjacent to the displaying area and a cutting part located at outside peripheral of the effective part; setting an electrode on the displaying area of the first substrate and the second substrate; setting a controlling circuit and a plurality of connecting terminals of the controlling circuit on the non-displaying area of at least one of the first substrate and the second substrate for controlling a voltage applied to the electrode; sealing a plurality of liquid crystal molecules in the displaying area between the first substrate and the second substrate by a plurality of sealants; applying a predetermined voltage to the electrode via the controlling circuit for executing a photo-alignment treatment to the liquid crystal molecules; and cutting off the cutting part.

Wherein, the controlling circuit on the non-displaying area of the first substrate is a curing circuit for executing the photo-alignment.

Wherein, the electrode on the displaying area of the first substrate is a pixel electrode and the pixel electrode is connected to the curing circuit in the non-display area.

Wherein, the location of the insulating pattern is selected from the group consisting of a position in the non-displaying corresponding to the curing circuit and a position on the curing circuit.

The display motherboard, the display panel made from the display motherboard and the manufacturing method of the display panel use the insulating pattern to isolate a number of metal particles or conducting impurities falling on the curing circuit in the manufacturing process from the other circuit or the terminals. Therefore, the curing circuit is avoided from being shortened by the metal particles or the conducting impurities falling thereon.

### BRIEF DESCRIPTION OF THE DRAWINGS

In order to illustrate technical schemes of the present invention or the prior art more clearly, the following section briefly introduces drawings used to describe the embodiments and prior art. Obviously, the drawing in the following descriptions just is some embodiments of the present invention. The ordinary person in the related art can acquire the other drawings according to these drawings without offering creative effort.

FIG. 1 is a schematic structural view of a display motherboard in accordance with an embodiment of the present invention;

FIG. 2 is a schematic structural view of a display panel in accordance with an embodiment of the present invention; and

FIG. 3 is a flow chart of steps of a display panel manufacturing method in accordance with an embodiment of the present invention.

### DETAILED DESCRIPTION OF THE PREFERRED EMBODIMENTS

The following sections offer a clear, complete description of the present invention in combination with the embodiments and accompanying drawings. Obviously, the embodiments described herein are only a part of, but not all of the embodiments of the present invention. In view of the embodiments described herein, any other embodiment obtained by the person skilled in the field without offering creative effort is included in a scope claimed by the present invention.

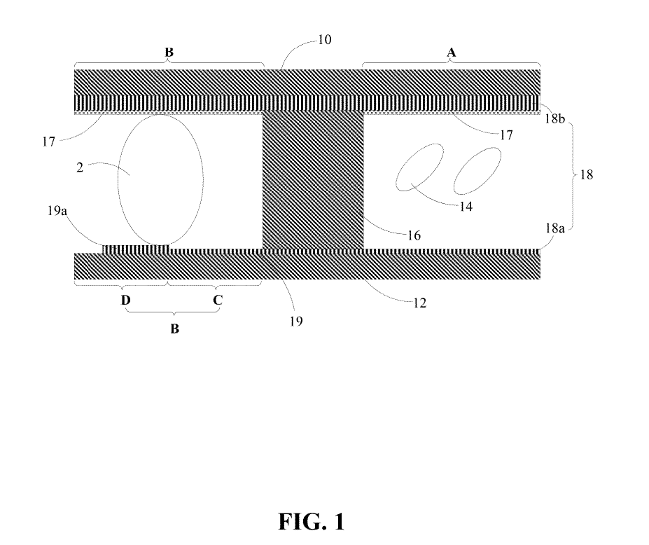

Referring to FIG. 1, a display motherboard in accordance with an embodiment of the present invention includes a first substrate 10, a second substrate 12, and a number of liquid crystal molecules 14 disposed between the first substrate 10 and the second substrate 12. Each of the first substrate 10 and the second substrate 12 includes a display area A and a non-displaying area B. The displaying area A of the first substrate 10 corresponds to the displaying area A of the second displaying area B. The non-displaying area B of the first substrate 10 corresponds to the non-displaying area B of the second substrate 12. The non-displaying area B of at least one of the first substrate 10 and the second substrate 12 includes an effective part C adjacent to the displaying area A and a cutting part D located at outside peripheral of the effective part C. The liquid crystal molecules 14 are sealed in the displaying area A between the first substrate 10 and the second substrate 12 by a number of sealants 16. The displaying area A of the first substrate 10 and the second substrate 12 includes an electrode 18 set thereon. The non-displaying area B of at least one of the first substrate 10 and the second substrate 12 includes a controlling circuit 19 for controlling a voltage applied to the electrode 18 and a number of connecting terminals 19a of the controlling circuit 19 set on the cutting part D. The non-displaying area B of at least one of the first substrate 10 and the second substrate 12 includes an insulating pattern 17 set corresponding to the controlling circuit 19. The insulating pattern 17 does not set on the connecting terminals 19a. The first substrate 10 and the second substrate 12 are selected from a group consisting of a thin film transistor (TFT) substrate and a color filter (CF) substrate. The whole of the controlling circuit 19 may be set on the effective part C, or a part of the controlling circuit 19 is set on the effective part and the other part of the controlling circuit 19 is set on the cutting part D. In this embodiment, the first substrate is the thin film transistor substrate. The second substrate is the color filter substrate. The whole of the controlling circuit 19 is set on the effective part C.

The controlling circuit 19 is used to control the voltage applied to the electrode 18 in the displaying area A according to a received display signal, thus to regulate the orientation of the liquid crystal molecules 14 for displaying picture. In this embodiment, the controlling circuit 19 set on the non-displaying area B of the first substrate 10 is a curing circuit. The electrode 18 located in the displaying area A of the first substrate 10 is a pixel electrode 18a. The pixel electrode 18a is electrical connected to the curing circuit 19 located in the non-displaying area B. The curing circuit 19 is configured to provide a predetermined voltage to the liquid crystal molecules 14 via the pixel electrode 18a to cure the alignment of the liquid crystal molecules during the photo-alignment process.

The electrode 18 located on the second substrate 12 is a common electrode 18b. The common electrode 18b covers the displaying area A and the non-displaying area B of the second substrate 12. The common electrode 18b is configured to provide a common voltage, thus to form an electric filed to control rotation of the liquid crystal molecules 14 in cooperation with the pixel electrode 18a on the first substrate 10.

In this embodiment, the insulating pattern 17 located in the non-displaying area B corresponding to the curing circuit 19 is a polymer alignment film. The material of the polymer alignment film is polyimide.

Because the insulating pattern 17 can insulate from the electricity, a number of metal particles or conducting impurities falling on the curing circuit 19 are isolated from the other circuit or terminals by the insulating pattern 17.

It is understood that the insulating pattern 17 may be set on the non-displaying area B of the first substrate 10 or on the non-displaying area B of both the first substrate 10 and the second substrate 12.

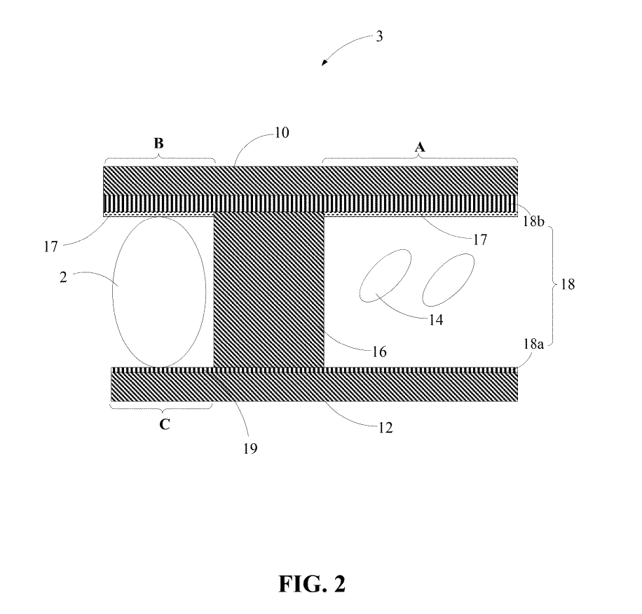

Referring to FIG. 2, a structure of a display panel 3 in accordance with an embodiment of the present invention is similar to the display motherboard 1. A difference between the display panel 3 and the display motherboard 1 is that the cutting part D of the non-displaying area B on the first substrate 10 and the second substrate 12 of the display panel 3 is cut out after the photo-alignment process. That is, the connecting terminals 19a or a part of controlling circuit 19 formed on the cutting part D is cut out. The remaining controlling circuit 19 located on the non-displaying area B of at least one of the first substrate 10 and the second substrate 12 control the voltage applied to the electrode 18. The insulating pattern 17 is set on the non-displaying area B of at least one of the first substrate 10 and the second substrate 12 corresponding to the remaining controlling circuit 19.

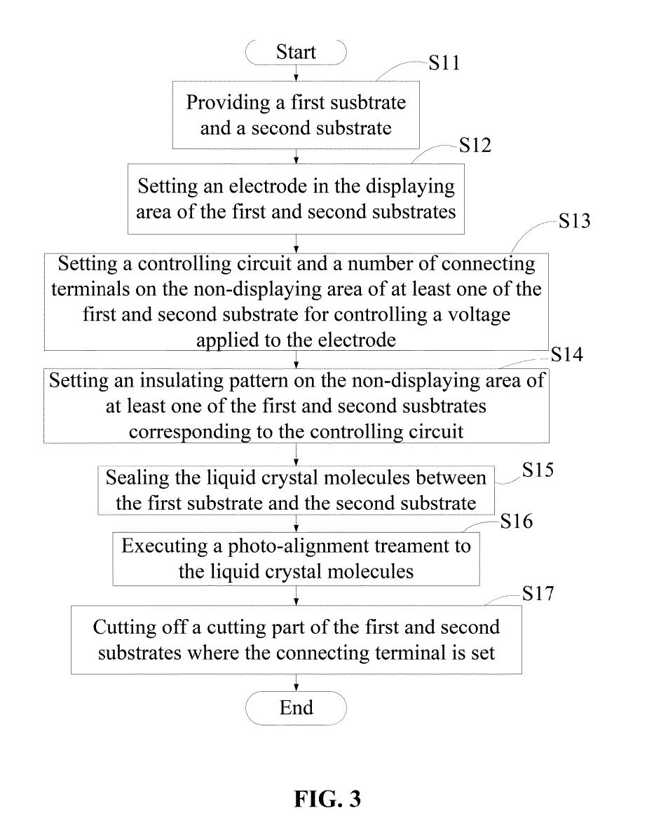

Referring to FIG. 3, a manufacturing method of display panel in accordance with an embodiment of the present invention includes following steps:

Step S11, a first substrate 10 and a second substrate 12 parallel to the first substrate 10 are provided. Each of the first substrate 10 and the second substrate 12 includes a display area A and a non-displaying area B. The displaying area A of the first substrate 10 corresponds to the displaying area A of the second displaying area B. The non-displaying area B of the first substrate 10 corresponds to the non-displaying area B of the second substrate 12. The non-displaying area B of at least one of the first substrate 10 and the second substrate 12 includes an effective part C adjacent to the displaying area A and a cutting part D located at outside peripheral of the effective part C.

The first substrate 10 and the second substrate 12 are selected from one of TFT substrate and CF substrate. In this embodiment, the first substrate 10 is the thin film transistor substrate. The second substrate 12 is the color filter substrate.

Step S12, an electrode 18 is formed on the displaying area A of the first substrate 10 and the second substrate 12. The electrode 18 on the displaying area A of the first substrate 10 is pixel electrode 18a. The electrode 18 located on the second substrate 12 is a common electrode 18b. The common electrode 18b covers the displaying area A and the non-displaying area B of the second substrate 12. The common electrode 18b is configured to provide a common voltage, thus to form an electric filed to control rotation of the liquid crystal molecules 14 in cooperation with the pixel electrode 18a on the first substrate 10.

Step S13, a controlling circuit 19 which controls the voltage applied to the electrode 18 is set on the non-displaying area B of at least one of the first substrate 10 and the second substrate 12. A number of connecting terminals 19a of the controlling circuit 19 are set on the cutting part D. The controlling circuit 19 controls the voltage applied to the electrode 18 according to a received display signal, thus to regulate the orientation of the liquid crystal molecules 14 for displaying picture. The whole of the controlling circuit 19 may be set on the effective part C, or a part of the controlling circuit 19 is set on the effective part and the other part of the controlling circuit 19 is set on the cutting part D.

In this embodiment, the pixel electrode 18a is electrical connected to the controlling circuit 19 in the non-displaying area B. The controlling circuit 19 controls the voltage applied to the pixel electrode 18a. The whole of the controlling circuit 19 is set on the effective part C. The controlling circuit 19 on the non-displaying area B of the first substrate 10 is a curing circuit. The curing circuit 19 is configured to provide a predetermined voltage to the liquid crystal molecules 14 via the pixel electrode 18a to cure the alignment of the liquid crystal molecules during the photo-alignment process.

Step S14, an insulating pattern 17 is set on the non-displaying area B of at least one of the first substrate 10 and the second substrate 12 corresponding to the controlling circuit 19. In this embodiment, the insulating pattern 17 set on the non-displaying area B corresponding to the curing circuit 19 is a polymer alignment film. The material of the polymer alignment film is polyimide.

Because the insulating pattern 17 can insulate from the electricity, a number of metal particles or conducting impurities falling on the curing circuit 19 are isolated from the other circuit or terminals by the insulating pattern 17.

Step S15, a number of liquid crystal molecules 14 are sealed in the displaying area A between the first substrate 10 and the second substrate 12.

Step S16, the curing circuit 19 applies a predetermined voltage to the electrode 18 to execute a photo-alignment process of the liquid crystal molecules 14.

Step S17, the cutting part D of the first substrate 10 and the second substrate 12 is cut off to acquire a display panel 3.

What is said above are only preferred examples of present invention, not intended to limit the present invention, any modifications, equivalent substitutions and improvements etc. made within the spirit and principle of the present invention, should be included in the protection range of the present invention.

What is claimed is:

1. A display motherboard, comprising:
a first substrate;
a second substrate opposite to the first substrate; and
a plurality of liquid crystal molecules sealed between the first substrate and the second substrate by a plurality of sealants;
wherein each of the first substrate and the second substrate comprises a display area, a non-displaying area, and an electrode set on the displaying area, the non-displaying area of at least one of the first substrate and the second substrate comprises an effective part adjacent to the displaying area, a cutting part located at outside peripheral of the effective part, a controlling circuit for controlling a voltage applied to the electrode, a plurality of connecting terminals connected to the controlling circuit set on the cutting part, and an insulating pattern corresponding to the controlling circuit, the insulating pattern is not set on the connecting terminals.

2. The display motherboard of claim 1, wherein the first substrate is a thin film transistor substrate.

3. The display motherboard of claim 1, wherein the second substrate is a color filter substrate.

4. The display motherboard of claim 1, wherein the controlling circuit on the non-displaying area of the first substrate is a curing circuit for the photo-alignment treatment.

5. The display motherboard of claim 4, wherein the electrode set on the displaying area of the first substrate is a pixel electrode, and the pixel electrode is connected to the curing circuit.

6. The display motherboard of claim 4, wherein the location of the insulating pattern is selected from the group consisting of a position in the non-displaying corresponding to the curing circuit and a position on the curing circuit.

7. The display motherboard of claim 1, wherein the electrode on the second substrate is a common electrode and the common electrode covers the non-displaying area and the displaying area of the second substrate.

8. The display motherboard of claim 1, wherein a material of the insulating pattern is polymer alignment film.

9. A display panel, comprising:
a first substrate;
a second substrate opposite to the first substrate; and
a plurality of liquid crystal molecules sealed between the first substrate and the second substrate by a plurality of sealants;
wherein each of the first substrate and the second substrate comprises a display area, a non-displaying area, an electrode set on the displaying area, a controlling circuit remains on the non-displaying area of at least one of the first substrate and the second substrate after being cut, and an insulating pattern corresponding to the remaining controlling circuit.

10. The display panel of claim 9, wherein the first substrate is a thin film transistor substrate.

11. The display panel of claim 9, wherein the second substrate is a color filter substrate.

12. The display panel of claim 9, wherein the controlling circuit on the non-displaying area of the first substrate is a curing circuit for the photo-alignment treatment.

13. The display panel of claim 12, wherein the electrode set on the displaying area of the first substrate is a pixel electrode, and the pixel electrode is connected to the curing circuit.

14. The display panel of claim 12, wherein the location of the insulating pattern is selected from the group consisting of a position in the non-displaying corresponding to the curing circuit and a position on the curing circuit.

15. The display panel of claim 9, wherein the electrode on the second substrate is a common electrode and the common electrode covers the non-displaying area and the displaying area of the second substrate.

16. The display panel of claim 9, wherein a material of the insulating pattern is polymer alignment film.

17. A manufacturing method of a display panel, comprising:
providing a first substrate and a second substrate parallel to the first substrate, wherein each of the first substrate and the second substrate comprises a display area and a non-displaying area, and the non-displaying area of at least one of the first substrate and the second substrate comprises an effective part adjacent to the displaying area and a cutting part located at outside peripheral of the effective part;
setting an electrode on the displaying area of the first substrate and the second substrate;
setting a controlling circuit and a plurality of connecting terminals of the controlling circuit on the non-displaying area of at least one of the first substrate and the second substrate for controlling a voltage applied to the electrode;
sealing a plurality of liquid crystal molecules in the displaying area between the first substrate and the second substrate by a plurality of sealants;
applying a predetermined voltage to the electrode via the controlling circuit for executing a photo-alignment treatment to the liquid crystal molecules; and
cutting off the cutting part.

18. The manufacturing method of claim 17, wherein the controlling circuit on the non-displaying area of the first substrate is a curing circuit for executing the photo-alignment.

19. The manufacturing method of claim 18, wherein the electrode on the displaying area of the first substrate is a pixel electrode and the pixel electrode is connected to the curing circuit in the non-display area.

20. The manufacturing method of claim 18, wherein the location of the insulating pattern is selected from the group consisting of a position in the non-displaying corresponding to the curing circuit and a position on the curing circuit.
